(19) United States
(12) Patent Application Publication
(10) Pub. No.: US 2008/0143533 A1
(43) Pub. Date: Jun. 19, 2008

(54) Magnetoacoustic markers based on magnetic microwire, and method of obtaining the same

(76) Inventors: Pilar Marin Palacios, Pozuelo De Alarcon (Madrid) (ES); Daniel Cortina Blanco, Boadilla Del Monte (Madrid) (ES); Javier Calvo Robledo, Pozuelo De Alarcon (Madrid) (ES); Antonio Hernando Grande, Madrid (ES); Jose Juan Gomez Rebolledo, Madrid (ES)

Correspondence Address: WENDEROTH, LIND & PONACK, L.L.P., 2033 K STREET N. W., SUITE 800, WASHINGTON, DC, 20006-1021, US

(21) Appl. No.: 12/000,513

(22) Filed: Dec. 13, 2007

(30) Foreign Application Priority Data
Dec. 15, 2006 (ES) 200603200

(51) Int. Cl. G08B 13/14

(52) U.S. Cl. 340/572.5

(57) ABSTRACT

It concerns an activatable/deactivatable magnetomechanical marker, based on magnetic microwires, in which participates a non-bistable, magnetoelastic, soft magnetic microwire (1) with induced transversal magnetic anisotropy and with magnetoelastic resonance frequency of 58 kHz, and a second hard magnetic microwire (2), thereby achieving a substantial reduction in the size of the marker.

The procedure for obtaining the same consists firstly in obtaining a soft magnetic microwire with non-bistable magnetic behaviour, which undergoes a heat treatment in the presence of transversal magnetic field sufficient to saturate the sample at a temperature below that of crystallization of the amorphous alloy, cutting said magnetic wire to the appropriate length so that its magnetoelastic resonance coincides with that of the detecting unit, and finally obtaining a hard magnetic microwire (2) which together with the soft microwire are mounted on the mechanical support (3) of the marker.

### OBJECT OF THE INVENTION

The present invention relates to an activatable/deactivatable magnetic marker, for electronic article surveillance, based on the magnetoelastic resonance of magnetic microwires. The magnetic marker that the invention proposes is usable in systems for the electronic detection of articles, and is based on magnetic microwires obtained by Taylor's technique.

The invention lies within the technical field of magnetic materials and also covers aspects of electromagnetism, being of application in the environment of sensors and detectors and in that of metallurgy.

### BACKGROUND OF THE INVENTION

Taylor's technique is known for the production of microwires; it allows microwires to be obtained with very small diameters, of between one and several tens of microns, through a simple process. The microwires so obtained can be made from a great many magnetic and non-magnetic metals and alloys. This technique is described, for example, in the article “The Preparation, Properties and Applications of Some Glass Coated Metal Filaments Prepared by the Taylor-Wire Process”, W. Donald et al., Journal of Material Science, 31, 1996, pp 1139-1148.

The most important characteristic in the Taylor method or technique is that it allows metals and alloys to be obtained in microwire form with insulating coating in a unique and simple operation with the economy that this signifies for the manufacturing process.

The technique for obtaining magnetic microwires with insulating coating and amorphous microstructure is described, for example, in the article “Magnetic Properties of Amorphous Fe—P Alloys Containing Ga, Ge and As”, H. Wiesner and J. Schneider, Stat. Sol. (a) 26, 71 (1974), Phys. Stat. Sol. (a) 26, 71 (1974).

The properties of the magnetic amorphous microwire with insulating coating, in connection with the present invention, are described in the article “Amorphous glass-covered magnetic wires: preparation, properties, applications”, H. Chiriac, T. A. Óvárí, 1997. In: Progress in Material Science. Elsevier Science Ltd., Great Britain, Vol. 40, pp. 333-407.

The alloys utilised for the production of the microwire core are of the transition-metal metalloid type, and they have an amorphous microstructure. The influence of the microwire geometry on its magnetic behaviour is due to the magnetoelastic character of the alloys utilized which in turn depends on the magnetostriction constant of the same.

Systems for the detection of articles based on magnetic materials are well known. Picard's patent (French patent FR 763.681) reveals the first device of this type. The device disclosed is based on the use of a ribbon of soft magnetic material of the Permalloy type which when subjected to an alternating magnetic field induces harmonics in a detector clearly different to those coming from other types of metal.

Since Picard presented his patent much effort has been applied to improving the markers from the point of view both of size and their detectability with the distance to the receiver, as well as the possibility of making them activatable and deactivatable. The effort, in the main, has centred in looking for materials with lower coercivity and greater permeability than Permalloy. As the voltage pulse generated in the detector due to the presence of the marker depends on the characteristics of the hysteresis loop of the material utilized, the aim has always been to discover material with low coercivity and high permeability, so that higher order harmonics can be obtained with greater amplitude for lower values of the applied field, thereby making the marker easier to distinguish.

Amorphous magnetic materials in ribbon form have low coercivity and high susceptibility which can be optimized for use in equipment for electronic article detection by means of suitable heat treatments in the presence or not of magnetic field. Thus, for example, the American patent U.S. Pat. No. 6,475,303 relates to the use of compositions based on CoNiFeSiBC.

There are other materials that present clear advantages from the detection point of view. They are amorphous materials that have magnetic bistability in their hysteresis loop. This phenomenon is related with the appearance of a Barkhausen discontinuity in the hysteresis loop of the material for a certain value of the applied magnetic field. The material has a non-zero value of remanence magnetization for a null field. To reverse this magnetization it is necessary to apply a magnetic field in the opposite sense. The critical field is the minimum field necessary to achieve reversal of the magnetization. This behaviour is obtained, fundamentally in wires (“The magnetization reversal in amorphous wires”, M, Vazquez, D. X. Chen 1995 IEEE Trans. Magn. 31, 1229-1238) and in amorphous magnetic microwires with substantial longitudinal anisotropy due to their high magnetostriction constant (“Magnetic properties of glass-coated amorphous and nanocrystalline wires”, M. Vazquez, A. P. Zhukov 1996, J. Magn. Magn. Mat. 160, 223-228).

When a bistable magnetic material is used in a detecting system the pulse detected by its presence is substantially independent of the rate of variation of the magnetizing field and of the strength thereof, provided this strength is above a minimum threshold value.

In the American patent U.S. Pat. No. 4,660,025 a detecting system is revealed in which a bistable amorphous magnetic wire is used as marker, of 7.6 cm minimum length. In this case an alternating magnetic field is applied to a certain region of the space and an alarm is activated when a disturbance of said magnetic field is detected. This takes place when the marker is introduced in that region and the value of the magnetic field exceeds the critical field of the wire causing the magnetization to reverse. This is known as “snap-action”.

From the results obtained with this last type of material the advantages can be clearly deduced of the detectors based on bistable magnetic behaviour in which the marker is based on magnetic wires, but the major drawback observed is the substantial length of the marker.

Besides the advantages obtained in the marker of the patent U.S. Pat. No. 4,660,025 and which relate to its richness in harmonics and the high pulse, it is important to find the possibility of deactivating this type of magnetic material. The American patent U.S. Pat. No. 4,686,516 discloses a way of doing this based on the crystallization of the amorphous magnetic material. This is achieved by heating at least a part of the marker above its crystallization temperature either by applying an electric current or radiant energy such as a laser. Although some of the procedures herein disclosed allow the marker to be deactivated without touching it, they need to be applied carefully.

The American patent U.S. Pat. No. 4,980,670 reveals a magnetic marker for electronic article surveillance wherein the marker has “snap-action” for low threshold values of the applied magnetic field and the marker is also easily deactivatable. This patent includes the method of manufacturing the marker based on magnetic ribbons, the development of a detector and of a deactivator.

The conditions described in this patent for obtaining bistable magnetic behaviour of the hysteresis loop in amorphous ribbons, are based on special heat treatments applied to amorphous magnetic ribbons for pinning the walls of the magnetic domains. In this patent a certain number of compositions based on CoFeSiB are described, as well as the temperatures and treatment times.

The deactivation of this marker is carried out by subjecting the marker to a high-frequency and high-amplitude alternating magnetic field. In this way a great number of magnetic domains are created in the ribbon. The appearance of these domains in the ribbon inhibits the Barkhausen discontinuity in the hysteresis loop disabling the marker.

The American patent U.S. Pat. No. 5,313,192 develops a marker equivalent to that of the patent U.S. Pat. No. 4,980,670, but more stable and controllable. The processing conditions of the amorphous magnetic ribbon are the same but, additionally, the marker is subjected to predefined magnetic fields during the processing which allow it to be made activatable and deactivatable. More particularly, the marker of this invention contains a soft magnetic material that constitutes the main core and a second hard or semi-hard magnetic material. This marker is conditioned in such a way that the second material has activated and deactivated states respectively. In the activated state the marker exhibits bistable hysteresis, whilst in the deactivated state the marker has a hysteresis loop without Barkhausen discontinuities.

The American patent U.S. Pat. No. 6,747,559 relates to a permanent marker for electronic article detection based on magnetic microwires with low coercivity (less than 10 A/m) and high magnetic permeability (more than 20000). The length of the microwire or microwires utilized is not more than 32 mm. In this case it is the high permeability that allows higher order harmonics to be obtained with great amplitude for sufficiently low values of the applied field, thereby making the marker easy to distinguish.

The Spanish patent application P200500970(9) discloses an activatable/deactivatable magnetic marker based on magnetic microwires formed by two components wherein the first comprises a first set of segments of soft magnetic microwire with bistable magnetic behaviour, said segments being substantially aligned according to a direction parallel to the axial direction of the microwire, and the second component comprises a second set of segments of hard magnetic microwire, said segments of hard magnetic microwire being substantially equal in length, and they are arranged in an equidistant manner from each other and substantially aligned according to a direction parallel to that of the first component. This marker, in the activated state, works in the same way as that described in the patent U.S. Pat. No. 6,747,559.

All the systems described, based on the generation of harmonics, have a clear limitation in the detection distance. The amplitude of the harmonic detected in the receiver antenna is much smaller than that of the signal which the magnetic field generates in the detection area. This occurrence limits the detection range to about 90 cm. Another problem related with the generation of harmonics is the difficulty in distinguishing the signal of the marker from other pseudo-signals generated by any other type of metal (belts, eyeglasses, bracelets, etc.). Another problem with this type of marker is its tendency to deactivate or reactivate for conditions different to those imposed by the system itself. Magnetic markers can be deliberately deactivated by the juxtaposition of a permanent magnet or be activated accidentally by a loss of the magnetization of the hard magnetic component. For these reasons the equipment based on this technology prove operationally expensive and have too low sensitivity and reliability.

The patent U.S. Pat. No. 4,530,489 relates both to a detection system and to the corresponding marker thereof. It uses magnetomechanical markers that are formed by two elements: a magnetostrictive amorphous strip and a hard magnetic strip. The magnetostrictive element is designed in such a way that it resonates magnetoelastically at a predefined frequency provided it is saturated. The detecting unit generates an alternating magnetic field in the detection area at the predefined frequency in such a way that the magnetoelastic strip vibrates at said frequency. A receiver antenna is capable of receiving said vibration.

### DESCRIPTION OF THE INVENTION

The present invention proposes the production of a magnetomechanical marker based on magnetic microwires. This new design allows markers to be obtained of sizes smaller than those fabricated from magnetic ribbons. The marker object of the invention consists of two elements: magnetoelastic amorphous microwire and hard magnetic microwire.

In accordance with a first aspect of the present invention, this relates to an activatable/deactivatable magnetic marker formed by at least two components based on magnetic microwire, where:
the first component comprises a non-bistable magnetoelastic soft magnetic microwire with induced transversal magnetic anisotropy characterized in that it has a magnetoelastic resonance frequency of tens of kHz, preferably 58 kHz.
the second component is a hard magnetic microwire that allows the first component to be magnetized in the activation state of the marker.

Said soft magnetic microwire has to have a magnetoelastic composition of the type (Fe3-xCOx)60-80Si10-20B10-20.

The percentage of Cobalt should not be more than 40% by weight.

The diameter of the metallic core of the soft magnetic microwire should not be less than 40 μm and the thickness of the insulating coating must be between 10 and 30 μm.

The soft magnetic microwire must have a non-bistable low frequency hysteresis loop with transversal magnetic anisotropy.

The non-bistable hysteresis loop is obtained whenever the diameter of the metallic core of the microwire is more than 40 μm.

This magnetic behaviour at low frequency is obtained by heat treatment in the presence of magnetic field transversal to the magnetic microwire obtained by Taylor's technique.

The heat treatment is effective provided the thickness of the metallic core of the microwire is more than 40 μm.

The heat treatment temperature has to be less than the crystallization temperature of the amorphous alloy and the field applied has to allow saturation of the microwire at the treatment temperature.

The soft magnetic microwire has to have a magnetoelastic resonance frequency of the same value as the detection unit (58 kHz).

For a given soft magnetic microwire there will be a preferred length of the same for a value of the magnetic field produced by the hard microwire and which depends on the desired resonance frequency.

The marker has to be armed correctly so that it allows the soft magnetic microwire to resonate at the required frequency.

Said segments of hard magnetic microwire can be obtained by heat treatment above the crystallization temperature of amorphous microwires. That is, said segments of hard microwire can be obtained by heat treatments of amorphous magnetic microwires in general, they can or need not be the same as those of the soft part of the marker (if of interest, they can be).

Said marker can have a n activated state, obtained as a result of subjecting the same to an alternating magnetic field, and the hard magnetic microwire being demagnetized.

It can also have a deactivated state, obtained as a result of subjecting the same to a continuous magnetic field, and the hard magnetic microwire being magnetized in its remanence state.

Preferably the marker is configured to respond in its activated state to a magnetic field at a frequency equivalent to that of magnetoelastic resonance of the soft magnetic microwire.

The activatable/deactivatable magnetic marker of the invention can be used for electronic detection of objects.

Thus, the marker disclosed herein can be adapted and function in any equipment of those already existing, as well as be activated and deactivated in the pertinent equipment.

In accordance with a second aspect of the present invention, this relates to a method of obtaining the activatable/desactivatable magnetic marker, which method comprises:
obtaining a soft magnetic microwire with non-bistable magnetic behaviour,
subjecting said soft magnetic microwire to a heat treatment in the presence of transversal magnetic field sufficient to saturate the specimen at a temperature below that of crystallization of the amorphous alloy,
cutting the soft magnetic microwire to the appropriate length so that its magnetoelastic resonance, in the presence of the hard magnetic microwire, coincides with that of the detecting unit,
obtaining a hard magnetic microwire.

### DESCRIPTION OF THE DRAWINGS

To supplement the description that is being made and with the object of assisting in a better understanding of the characteristics of the invention, in accordance with a preferred example of practical embodiment thereof, attached as an integral part of said description, is a set of drawings wherein by way of illustration and not restrictively, the following has been represented:

FIG. 1. It shows the arrangement of the magnetic microwires on the mechanical support of a magnetoacoustic marker implemented in accordance with the object of the present invention.

FIG. 2.—It shows a bistable hysteresis loop associated with a soft magnetic microwire of appropriate thickness.

FIG. 3.—It shows the hysteresis loop associated with the soft magnetic microwire subjected to heat treatment in the presence of magnetic field.

FIG. 4.—It shows the circuit with which the resonance frequency of the microwire is determined.

FIG. 5.—It shows the response of an 8-cm microwire with hysteresis loop like that of FIG. 2 when, in the presence of a uniform magnetic field of 1 kOe it is subjected to a field of kHz of frequency between 14 and 54 kHz.

FIG. 6.—It shows the response of a 4-cm microwire with hysteresis loop like that of FIG. 3 when, in the presence of a uniform magnetic field of 1 kOe it is subjected to a field of kHz of frequency between 26 and 34 kHz.

### PREFERRED EMBODIMENT OF THE INVENTION

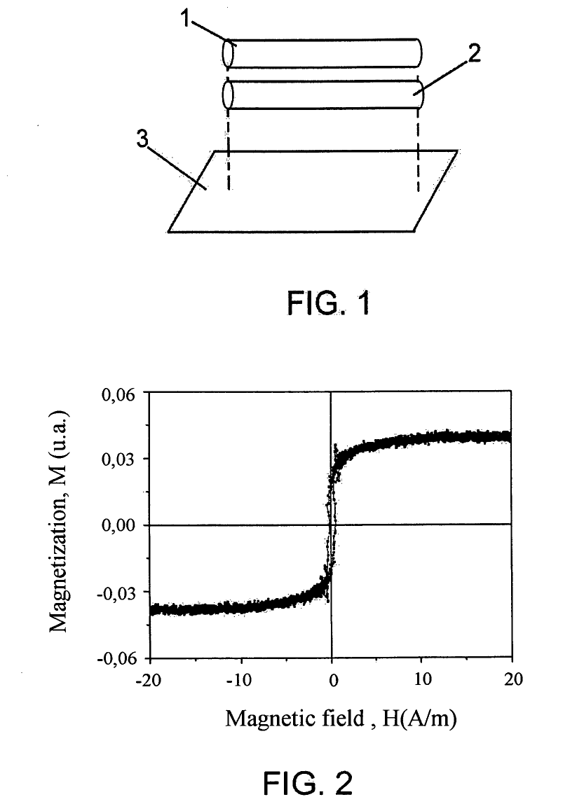

In the light of the foregoing figures and especially of FIG. 1, it can be observed how the marker that the invention proposes is provided with a soft magnetic microwire (1), of Fe45Co25Si15B10, with a metallic core thickness of 60 μm and insulating coating of 20 μm.

This microwire (1) undergoes a heat treatment at 200° C. for 1 hour, in the presence of a transversal magnetic field of 50 Oe. Moreover the hard magnetic microwire (2) has a coercivity of more than 60 KA/m, and a composition of CoNiCuMn.

Both microwires (1) and (2) are mounted on the mechanical support (3) of the marker.

The microwire so prepared is characterized previously in a device, the circuit of which appears represented in FIG. 4, formed by a function generator (4) which is connected to an excitation coil (5) inside which the magnetic microwire (1) is introduced. The signal produced by the microwire is picked up by another receiver coil (6) which is connected to a lock-in amplifier (7). The composition of the two signals is recorded in a computer (8). The microwire is in the presence of a magnet (9) generator of a 1 kOe field.

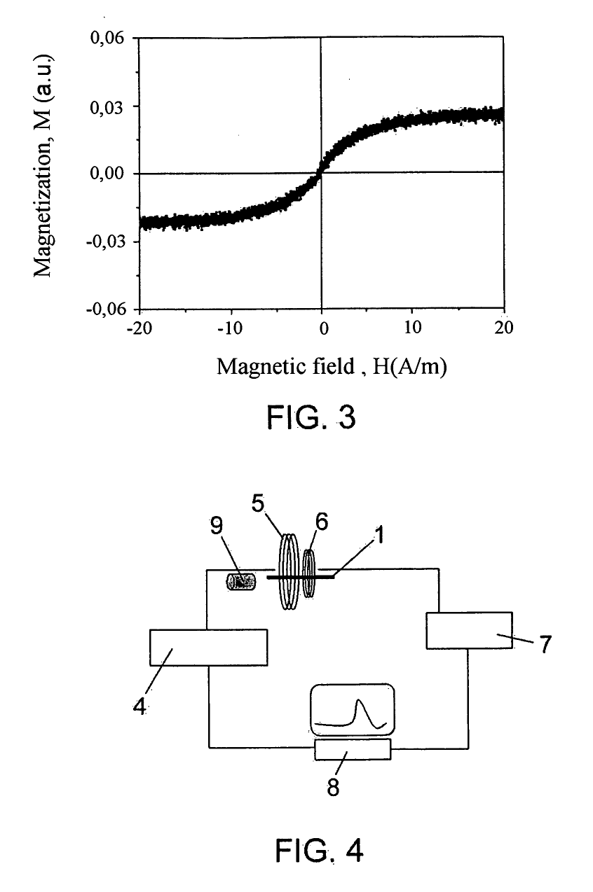

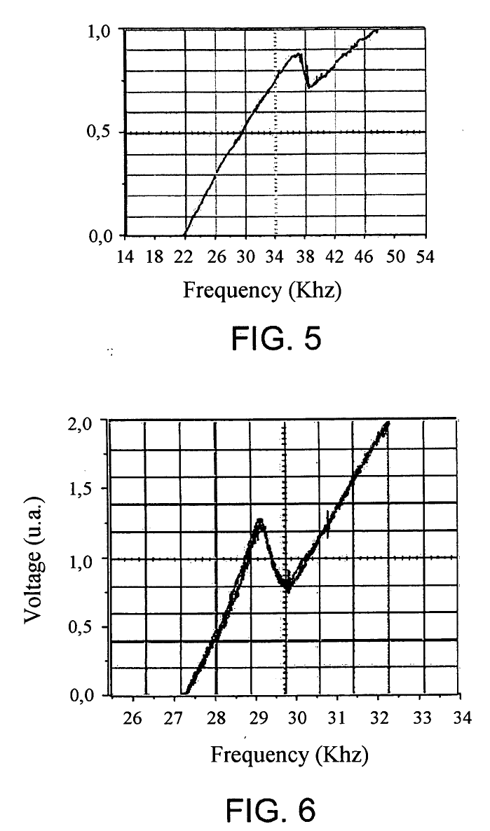

With a length of 4 centimetres a resonance frequency of 29 kHz is obtained, associated with the first vibration harmonic, for the microwire represented in FIG. 3.

This microwire responds in a commercial detection unit with excitation frequency of 58 kHz. Said frequency of 58 kHz corresponds to that of the second harmonic.

1. Magnetoacoustic marker based on magnetic microwire, characterized in that it is constituted at least by two components based on magnetic microwire, a first component comprising a non-bistable, magnetoelastic, soft, magnetic microwire (1), with induced transversal magnetic anisotropy and with a magnetoelastic resonance frequency of tens of kHz, preferably 58 kHz, and a second component consisting of a hard magnetic microwire (2), established on the mechanical support of the marker.

2. Magnetoacoustic marker based on magnetic microwire, according to claim 1, characterized in that the soft magnetic microwire (1) has a magnetoelastic composition of the type (Fe1-xCox)60-80Si10-20B10-20, the cobalt percentage should not be less than 20% by weight nor more than 40%, and the diameter or metallic core should not be less than 40 μm, the thickness of the insulating coating being between 10 and 30 μm.

3. Magnetoacoustic marker based on magnetic microwire, according to claim 1, characterized in that the soft magnetic microwire (1) has a non-bistable low-frequency hysteresis loop with transversal magnetic anisotropy.

4. Magnetoacoustic marker based on magnetic microwire, according claim 1, characterized in that the soft magnetic microwire (1) has a mangnetoelastic resonance frequency with the same value as the detection unit (58 kHz).

5. Magnetoacoustic marker based on magnetic microwire, according to claim 1, characterized in that the hard magnetic microwire (2) is obtained by heat treatment at a level higher than the crystallization temperature of the amorphous micro wires.

6. Method of obtaining the marker of the claim 1, characterized in that it comprises the following operative phases:
Obtaining a soft magnetic microwire (1) with non-bistable magnetic behaviour.
Subjecting said soft magnetic microwire to a heat treatment in the presence of transversal magnetic field, sufficient to saturate the sample at a temperature below that of crystallization of the amorphous alloy.
Cutting the soft magnetic microwire to the appropriate length so that the magnetoelastic resonance thereof coincides with that of the detecting unit.
Obtaining a hard magnetic microwire.
Assembly of the soft (1) and hard (2) magnetic microwires on the mechanical support (3) of the marker.

7. Method of obtaining the marker of the claim 5, characterized in that it comprises the following operative phases:
Obtaining a soft magnetic microwire (1) with non-bistable magnetic behaviour.
Subjecting said soft magnetic microwire to a heat treatment in the presence of transversal magnetic field, sufficient to saturate the sample at a temperature below that of crystallization of the amorphous alloy.
Cutting the soft magnetic microwire to the appropriate length so that the magnetoelastic resonance thereof coincides with that of the detecting unit.
Obtaining a hard magnetic microwire.
Assembly of the soft (1) and hard (2) magnetic microwires on the mechanical support (3) of the marker.

8. Method of obtaining the marker of the claim 4, characterized in that it comprises the following operative phases:
Obtaining a soft magnetic microwire (1) with non-bistable magnetic behaviour.
Subjecting said soft magnetic microwire to a heat treatment in the presence of transversal magnetic field, sufficient to saturate the sample at a temperature below that of crystallization of the amorphous alloy.
Cutting the soft magnetic microwire to the appropriate length so that the magnetoelastic resonance thereof coincides with that of the detecting unit.
Obtaining a hard magnetic microwire.
Assembly of the soft (1) and hard (2) magnetic microwires on the mechanical support (3) of the marker.

9. Method of obtaining the marker of the claim 3, characterized in that it comprises the following operative phases:
Obtaining a soft magnetic microwire (1) with non-bistable magnetic behaviour.
Subjecting said soft magnetic microwire to a heat treatment in the presence of transversal magnetic field, sufficient to saturate the sample at a temperature below that of crystallization of the amorphous alloy.
Cutting the soft magnetic microwire to the appropriate length so that the magnetoelastic resonance thereof coincides with that of the detecting unit.
Obtaining a hard magnetic microwire.
Assembly of the soft (1) and hard (2) magnetic microwires on the mechanical support (3) of the marker.

10. Method of obtaining the marker of the claim 2, characterized in that it comprises the following operative phases:
Obtaining a soft magnetic microwire (1) with non-bistable magnetic behaviour.
Subjecting said soft magnetic microwire to a heat treatment in the presence of transversal magnetic field, sufficient to saturate the sample at a temperature below that of crystallization of the amorphous alloy.
Cutting the soft magnetic microwire to the appropriate length so that the magnetoelastic resonance thereof coincides with that of the detecting unit.
Obtaining a hard magnetic microwire.
Assembly of the soft (1) and hard (2) magnetic microwires on the mechanical support (3) of the marker.

11. Magnetoacoustic marker based on magnetic microwire, according to claim 4, characterized in that the hard magnetic microwire (2) is obtained by heat treatment at a level higher than the crystallization temperature of the amorphous micro wires.

12. Magnetoacoustic marker based on magnetic microwire, according to claim 3, characterized in that the hard magnetic microwire (2) is obtained by heat treatment at a level higher than the crystallization temperature of the amorphous micro wires.

13. Magnetoacoustic marker based on magnetic microwire, according to claim 2, characterized in that the hard magnetic microwire (2) is obtained by heat treatment at a level higher than the crystallization temperature of the amorphous micro wires.

14. Magnetoacoustic marker based on magnetic microwire, according to claim 3, characterized in that the soft magnetic microwire (1) has a mangnetoelastic resonance frequency with the same value as the detection unit (58 kHz).

15. Magnetoacoustic marker based on magnetic microwire, according to claim 2, characterized in that the soft magnetic microwire (1) has a mangnetoelastic resonance frequency with the same value as the detection unit (58 kHz).

16. Magnetoacoustic marker based on magnetic microwire, according to claim 2, characterized in that the soft magnetic microwire (1) has a non-bistable low-frequency hysteresis loop with transversal magnetic anisotropy.
